(19) United States
(12) Patent Application Publication
(10) Pub. No.: US 2015/0156843 A1
(43) Pub. Date: Jun. 4, 2015

(54) LED CONTROL SYSTEM AND LED LIGHT USING SAME

(71) Applicant: HON HAI PRECISION INDUSTRY CO., LTD., New Taipei (TW)

(72) Inventor: CHIANG-KUO TANG, New Taipei (TW)

(21) Appl. No.: 14/554,253

(22) Filed: Nov. 26, 2014

(30) Foreign Application Priority Data
Nov. 30, 2013 (CN) 201310622461.8

(51) Int. Cl. H05B 33/08; H05B 37/02

(52) U.S. Cl. CPC H05B 33/0845; H05B 33/0857; H05B 37/0281

(57) ABSTRACT

An LED control system includes a power module, an LED emitting module, and a process module. The LED emitting module is electrically connected to the power module. The process module is electrically connected with the power module and the LED emitting module. The process module includes a mode process unit. The process module supplies a plurality of LED emitting modes for choosing. The LED emitting module emits light in a preset fashion for each LED emitting mode with corresponding emitting colors, emitting time, emitting intensity. The input module is configured to control operations of the power module, the LED emitting module, and the process module. The disclosure also supplies an LED light using the LED control system.

### FIELD

The subject matter herein generally relates to a LED control system and a LED light using the same.

### BACKGROUND

An illumination light is a device, which is supplied with electric power and transforms the electrical energy into a light energy. LED lights are popular used.

### BRIEF DESCRIPTION OF THE DRAWINGS

Implementations of the present technology will now be described, by way of example only, with reference to the attached figures.

FIG. 1 illustrates an isometric view of a LED light using the LED control system.

FIG. 2 is similar to the FIG. 1, but from another angle.

FIG. 3 illustrates a block diagram of the LED control system.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure is in relation to an LED control system and an LED light using the LED control system. The LED control system can include a power module, an LED emitting module, and a process module. The LED emitting module can be electrically connected to the power module. The process module can be electrically connected with the power module and the LED emitting module. The process module can include a mode process unit. The process module can supply a plurality of LED emitting modes for choosing. The LED emitting module can emit light in a preset fashion for each LED emitting mode with corresponding emitting colors, emitting time, emitting intensity. The input module can be configured for controlling operations of the power module, the LED emitting module, and the process module. A control signal can be input for one LED emitting mode via the input module, and the process module can receive the control signal and drive the LED emitting module to emit in one corresponding LED emitting mode.

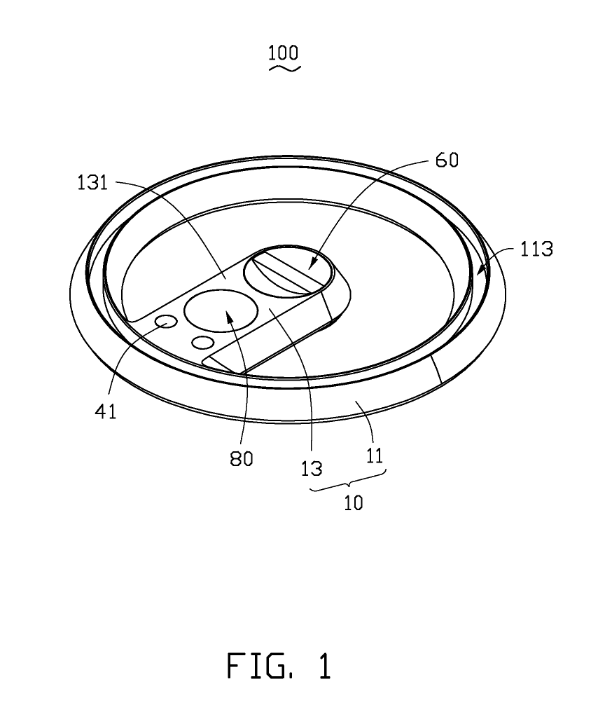

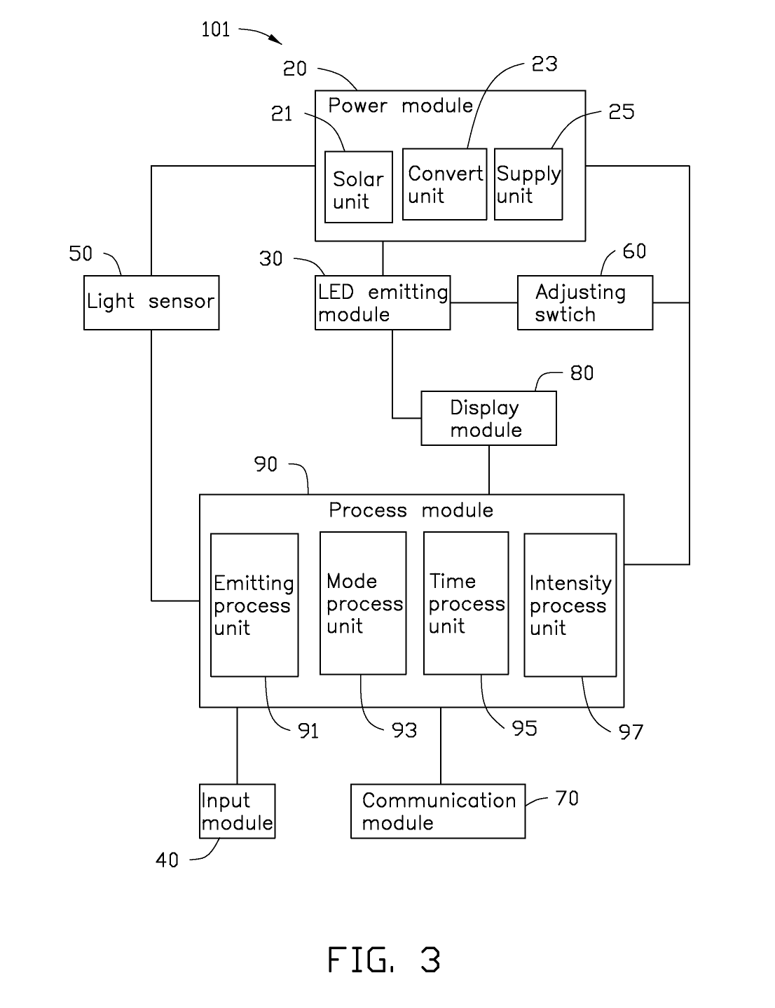

FIG. 1 illustrates an LED light 100 for illumination or decoration. The LED light 100 can include housing 10 and an LED control system 101 (as shown in FIG. 3) positioned on the housing 10.

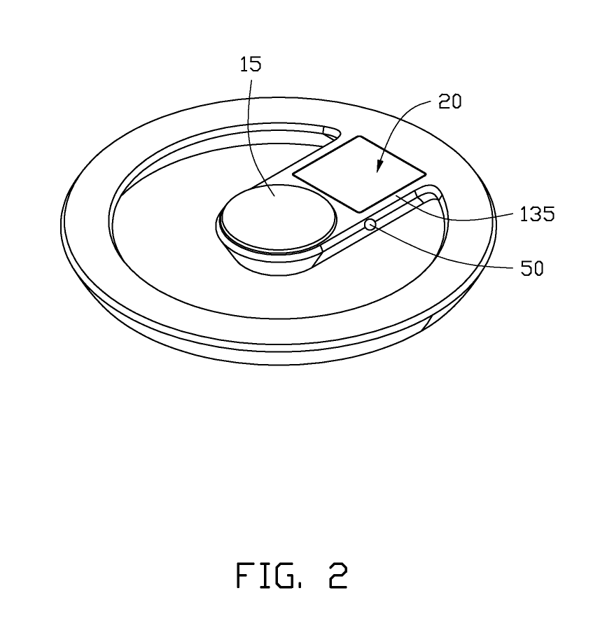

Also referring to the FIG. 2, the housing 10 can include a main body 11 and a mounting body 13. The main body 11 can be in a substantial ring shape. A receiving portion 113 can be defined in one side of the main body 11 along a circumferential direction of the main body 11. The mounting body 13 can extend from an inner sidewall of the main body 11 along a radius direction of the main body 11. The mounting body 13 can include a first mounting portion 131 and a second mounting portion 135 opposite to the first mounting portion 131. The first mounting portion 131 can be positioned at a same side with the receiving portion 113 of the housing 10. The housing 10 can further include an installation body 15 positioned on the second mounting portion 135 away from the main body 11, which is configured for installing the LED light 100 on a wall, or a glass, and other objects. In an illustrated embodiment, the installation body 15 is a sucker for sucking on a glass. In other embodiments, the installing body 15 can be an adhesive element or other fixture structure.

Also referring to FIG. 3, the LED control system 101 can include a power module 20, an LED emitting module 30, an input module 40, an adjusting switch 60, a display module 80, and a process module 90. The power module 20 can electrically coupled with the LED emitting module 30, an input module 40, an adjusting switch 60, a display module 80, and a process module 90 for supplying power.

The power module 20 can be mounted in the second mounting portion 15 adjacent to the installation body 15. The power module 20 can be a solar power supply module. In detail, the power module 20 can include a solar unit 21, a convert unit 23, and a supply unit 25. The solar unit 21 can be used for absorbing solar energy. The convert unit 23 can be used for converting the solar energy to be electrical energy. The supply unit 25 can be used for storing the electrical energy.

The LED emitting module 30 can be mounted and received in the receiving portion 113. The LED emitting module 30 can be electrically coupled to the power module 20 and the process module 90. The LED emitting module 30 can include a plurality of LED emitting point sources arrayed in the receiving portion 113. A distance can exist between a top surface of the LED emitting module 30 and a top surface of the main body 11 for protecting users' privacy. The LED emitting module 30 can emit different color light, such as red, green, blue, and yellow. In other embodiments, the LED emitting module 30 can be designed to include a plurality of ring-shaped LED pipes or ribbons.

The input module 40 can be electrically connected to the process module 90. The input module 40 can include two buttons 41 mounted on the first mounting portion 131. The input module 40 can be used for users controlling operations of the power module 20, the LED emitting module 30, and the process module 90.

The adjusting switch 60 can be positioned on the first mounting portion 131 away from the main body 11. The adjusting switch 60 can be electrically coupled to the LED emitting module 30 and the process module 90 for manually adjusting emitting intensity of the LED module 30. In the illustrated embodiment, a rotation of the adjusting switch 60 can adjust the emitting intensity of the LED module 30.

The display module 80 can be located on the first mounting portion 131 between the adjusting switch 60 and the two buttons 41. The display module 80 can be used for displaying working data of the LED light 100. The display module 80 can be electrically coupled to the process module 90 and the LED emitting module 30, respectively.

The process module 90 can include an emitting process unit 91, a mode process unit 93, and a time process unit 95. The emitting process unit 91 can be configured for supplying LED emitting color, emitting time, emitting intensity. Users can control emitting color, emitting time, emitting intensity via the inputting module 40 or an outer control device after processed by the emitting process unit 91. The mode process unit 93 can be configured to supply a plurality of modes for users choosing. The LED emitting module 30 can emit light in a preset fashion for each LED emitting mode with corresponding emitting color, emitting intensity and emitting time. In the illustrated embodiment, the plurality of LED emitting modes can include a standard mode, a sleep mode, a circulation mode, a physiological mode, an enjoy mode. The standard mode can be set as a usual working mode for the LED light 100 with a light intensity for illumination, and the LED emitting module 30 emit yellow light. The sleep mode can be set as a working state in deep night when users are sleep. The LED emitting module 30 for the sleep mode can emit blue light with weak light intensity thus without affecting users sleep. In the circulation mode, light emitted by the LED emitting module 30 can be circularly changed with time. Take the circulation mode for the LED light 100 in the illustrated embodiment for example, and a whole circulation time can be set to 28 days including four cycles, each cycle including seven days. In the first cycle, the LED emitting module 30 can emit red light. In the second cycle, the LED emitting module 30 can emit green light. In the third cycle, the LED emitting module 30 can emit blue light. In the third cycle, the LED emitting module 30 can emit green light.

The physiological mode can correspond users physiological cycle, usually for female physiological for reminding physiological cycle. A whole circulation time can be set to 30 days including five periods, and each period for the physiological mode including six days. The LED emitting module 30 can emit red light in the first period. The LED emitting module 30 can emit green light in the second period. The LED emitting module 30 can emit blue light in the third period. The LED emitting module 30 can emit green light in the fourth period. The LED emitting module 30 can emit blue light in the fifth period. The LED emitting module 30 can shine with changeable light color when the LED light 100 is set in the enjoy mode. In other embodiments, users can set other modes according to own favorite, such as their mood cycles.

The time process unit 93 can be configured for supplying real time for users, such as year, month, and date. The real time will be displayed by the displayed module 80. The time process unit 93 can also have a timing function via setting with the inputting module 40. The LED emitting module 30 will shin for reminding people when arriving at a scheduled time.

The LED control system 101 can further include a light sensor 50 electrically coupled to the power module 20 and the process module 90. The light sensor 50 can be positioned in the second receiving portion 135. The light sensor 50 can be used for detecting light intensity. The process module 90 can further include an intensity process unit 97. A preset light intensity value can be set via the input module 40 and stored by the intensity process unit 97. In detail, light intensity detected by the light sensor 50 can be transmitted to the intensity process unit 97 in real time. The LED emitting module 30 can be driven to emit light when the light intensity detected by the light sensor 50 is less than the preset light intensity value. The LED emitting module 30 can be driven to shut down when the light intensity detected by the light sensor 50 is greater than the preset light intensity value for saving energy.

The LED control system 101 can further include a communication module 70 electrically coupled to the process module 90 for wireless coupling with a control device, such a mobile phone, a remote controller, a computer. The communication module 70 can receive a control signal from the control device, and then transmit the control signal to the process module 90, so as to wireless control the LED control system 101. When the communication module 70 receives a control signal for one LED emitting mode from the control device, the communicating module 70 transmits the control signal to the process module 40, the process module 40 drives the LED emitting module 30 to emit light in one corresponding LED emitting mode.

In use, the LED light 100 can be mounted on a glass wall or a window glass via the installation body 15 for conveniently absorbing solar energy. The solar unit 21 can absorb solar energy, and the convert unit 23 can covert the solar energy to be electric energy. The LED emitting module 30 can be driven to emit light when the light intensity detected by the light sensor 50 is less than the preset light intensity value. The LED emitting module 30 can be driven to shut down when the light intensity detected by the light sensor 50 is greater than the preset light intensity value for saving energy. The users can choose or set a LED emitting mode, emitting color, emitting time according to their own favorites via the buttons 41 or the control device. For example, a control signal can be input for the sleep mode via the input module 40, and the process module 90 can receive the control signal, whereby the mode process unit 93 can drive the LED emitting module 30 to emit blue light with weak light intensity thus without affecting users sleep.

In other embodiments, the buttons 41 of the input module 40 can be omitted, the input module 40 can be the display module 80 when the display module 80 is designed to be a touch screen. Then the users can control or set the LED light 100 via the display module 80, or the control device.

In other embodiments, the power module 20 can be a battery for supplying power. The power module 20 also can further include a plug, and then the power module 20 can be directly electrically coupled to a power source.

In other embodiments, the adjusting switch 60 of the LED control system 101 can be omitted; the emitting intensity of the LED module 30 can be adjusted by the input module 40 or controlled by control devices.

In other embodiments, the mounting body 13 can be omitted, the power module 20, the input module 40, the adjusting switch 60, the display module 80, the process module 90, can be separately mounted on the main body 11.

In other embodiments, the installation body 15 can be omitted, a bracket, a recess can be positioned on the wall for positioning the LED light.

In other embodiments, a light sensor 50 can be omitted, the LED emitting module 30 can be operated to start work by manually or control devices.

The embodiments shown and described above are only examples. Many details are often found in the art such as the other features of a LED emitting module. Therefore, many such details are neither shown nor described. Even though numerous characteristics and advantages of the present technology have been set forth in the foregoing description, together with details of the structure and function of the present disclosure, the disclosure is illustrative only, and changes may be made in the details, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. An LED control system configured for an LED light, comprising:
a power module configured for supplying power;
an LED emitting module electrically connected to the power module;
a process module electrically connected to the power module and the LED emitting module respectively, the process module comprising:
a mode process unit configured to supply a plurality of LED emitting modes for choosing, the LED emitting module emitting light in a preset fashion for each LED emitting mode with corresponding emitting colors, emitting time, emitting intensity; and
an input module configured for controlling operations of the power module, the LED emitting module, and the process module, wherein a control signal is input for one LED emitting mode via the input module, and the process module receives the control signal and drives the LED emitting module to emit in one corresponding LED emitting mode.

2. The LED control system of claim 1, further comprising a display module electrically coupled to the process module and the LED emitting module.

3. The LED control system of claim 2, wherein the process module further comprises a time unit configured to supply real time, and the real time is displayed by the display module.

4. The LED control system of claim 3, wherein the time unit further have a timing function to remind users via the LED emitting module shining

5. The LED control system of claim 1, further comprising an adjusting switch electrically coupled to the LED emitting module and the process module, wherein the process module further comprises an emitting process unit, and the adjusting switch is configured to adjust LED emitting intensity of the LED emitting module.

6. The LED control system of claim 1, further comprising a light sensor electrically coupled to the power module for detecting light intensity, wherein the process module further comprises an intensity process unit, a preset light intensity value is set via the input module and stored by the intensity process unit, a light intensity detected by the light sensor is transmitted to the intensity process unit in real time, the LED emitting module is driven to emit light when the light intensity detected by the light sensor is less than the preset light intensity value; the LED emitting module is driven to shut down when the light intensity detected by the light sensor is greater than the preset light intensity value for saving energy.

7. The LED control system of claim 1, wherein the power module comprises a solar unit, a convert unit, and a supply unit, the solar unit is configured to absorb solar energy, the convert unit is configured for converting the solar energy to be electric energy, and the supply unit is configured for storing the electric energy.

8. The LED control system of claim 1, further comprising a communicating module electrically coupled to the process module, and the communicating module is configured to receive control signals from other control devices, so as to wireless control the LED control system.

9. An LED light, comprising:
a housing; and
an LED control system mounting in the housing, comprising:
a power module mounted on the housing and configured to supply power;
an LED emitting module mounted on the housing and spaced from the power module, the LED emitting module electrically connected to the power module; and
a process module received in the housing, the process module electrically connected with the power module and the LED emitting module respectively, the process module comprising:
a mode process unit configured to supply a plurality of LED emitting modes for choosing, the LED emitting module emitting light in a preset fashion for each LED emitting mode with corresponding emitting colors, emitting time, emitting intensity; and
an input module configured to control operations of the power module, the LED emitting module, and the process module,
wherein a control signal is input for one LED emitting mode via the input module, and the process module receives the control signal and drives the LED emitting module to emit light in one corresponding LED emitting mode.

10. The LED light of claim 9, wherein the housing comprises a main body and a mounting body, the mounting body extends from an inner sidewall of the main body, the LED emitting module is mounted in the main body, and the power module, the input module, and the process module are positioned on the mounting body.

11. The LED light of claim 10, wherein a receiving portion is defined in one side of the main body, and the LED emitting module is received in the receiving portion.

12. The LED light of claim 10, wherein the mounting body comprises a first mounting portion and a second mounting portion opposite to the first mounting portion, the first mounting portion and the LED emitting module are positioned at a same side of the housing, the input module is positioned on the first mounting portion, and the power module is positioned on the second mounting portion.

13. The LED light of claim 10, wherein the housing further comprises an installation body positioned on the mounting body away from the main body.

14. The LED light of claim 10, wherein the module group further comprises a display module electrically coupled to the process module and the LED emitting module, the display module is mounted on the housing.

15. The LED light of claim 14, wherein the process module further comprises a time unit configured to supply real time, and the real time is displayed by the display module.

16. The LED light of claim 15, wherein the time unit further have a timing function to remind users via the LED emitting module shining

17. The LED light of claim 9, wherein the LED control system further comprises an adjusting switch electrically coupled to the LED emitting module and the process module, the adjusting switch is positioned on the housing, the process module further comprises an emitting process unit, and the adjusting switch is configured to adjust LED emitting intensity of the LED emitting module.

18. The LED light of claim 9, wherein the LED control system further comprises a light sensor electrically coupled to the power module and configured to detect light intensity, the process module further comprises an intensity process unit, a preset light intensity value is set via the input module and stored by the intensity process unit, a light intensity detected by the light sensor is transmitted to the intensity process unit in real time, the LED emitting module is driven to emit light when the light intensity detected by the light sensor is less than the preset light intensity value; the LED emitting module is driven to shut down when the light intensity detected by the light sensor is greater than the preset light intensity value for saving energy.

19. The LED light of claim 9, wherein the power module comprises a solar unit, a convert unit, and a supply unit, the solar unit is configured to absorb solar energy, the convert unit is configured for converting the solar energy to be electric energy, and the supply unit is configured for storing the electric energy.

20. An LED control system configured for an LED light, comprising:
a power module configured to supply power;
an LED emitting module electrically connected to the power module; and
a process module electrically connected with the power module and the LED emitting module, comprising:
a mode process unit configured to supply a plurality of LED emitting modes for choosing, the LED emitting module emitting light in a preset fashion for each LED emitting mode with corresponding emitting colors, emitting time, emitting intensity; and
a communicating module electrically coupled to the process module for receiving control signal from a control device and transmitting to the process module,
wherein the communicating module receives a control signal for one LED emitting mode from the control device, the communicating module transmits the control signal to the process module, then the process module drives the LED emitting module to emit light in one corresponding LED emitting mode.
